(19) United States
(12) Patent Application Publication
(10) Pub. No.: US 2010/0012695 A1
(43) Pub. Date: Jan. 21, 2010

(54) SADDLEBAG MOUNTING SYSTEM FOR A MOTORCYCLE

(75) Inventor: Mark J. DeMilio, Franklin, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 12/174,126

(22) Filed: Jul. 16, 2008

(51) Int. Cl. B62J 9/00

(52) U.S. Cl. 224/413

(57) ABSTRACT

A saddlebag mounting system for use with a motorcycle defining an aperture includes a saddlebag frame including a projection configured to extend at least partially through the aperture and having an undercut. The undercut is configured to receive a portion of the motorcycle frame adjacent to the aperture to couple the saddlebag frame to the motorcycle. The saddlebag mounting system also includes a saddlebag coupled to the saddlebag frame.

### BACKGROUND

The present invention relates to motorcycles and, more particularly, to saddlebag mounting systems for motorcycles.

It is known in the art to use saddlebags to store belongings on a motorcycle for a rider. It is also known to provide a mounting system for securing a saddlebag to the motorcycle and removing the saddlebag from the motorcycle without tools. Such mounting systems facilitate quick removal of the saddlebag in order to change the appearance of the motorcycle when the saddlebag is not needed.

### SUMMARY

In one embodiment, the invention provides a saddlebag mounting system for use with a motorcycle defining an aperture. The saddlebag mounting system includes a saddlebag frame including a projection configured to extend at least partially through the aperture and having an undercut. The undercut is configured to receive a portion of the motorcycle frame adjacent to the aperture to couple the saddlebag frame to the motorcycle. The saddlebag mounting system also includes a saddlebag coupled to the saddlebag frame.

In another embodiment, the invention provides a motorcycle including a motorcycle frame defining an aperture and a saddlebag mounting system. The saddlebag mounting system includes a saddlebag frame including a projection extending at least partially through the aperture and having an undercut. The undercut is configured to receive a portion of the motorcycle frame adjacent to the aperture to couple the saddlebag frame and the motorcycle frame. The saddlebag mounting system also includes a saddlebag coupled to the saddlebag frame.

In yet another embodiment, the invention provides a method of attaching a saddlebag frame to a motorcycle. The motorcycle includes a motorcycle frame defining an aperture. The method includes providing a projection having an undercut on the saddlebag frame, inserting the projection at least partially through the aperture, sliding the saddlebag frame relative to the motorcycle frame, and positioning a portion of the motorcycle frame within the undercut. The portion of the motorcycle frame is adjacent to the aperture. The method also includes coupling the saddlebag frame and the motorcycle frame.

Other aspects of the invention will become apparent by consideration of the detailed description and accompanying drawings.

### BRIEF DESCRIPTION OF THE DRAWINGS

FIG. 1 is a side view of a motorcycle including a saddlebag mounting system embodying the invention.

FIG. 2 is an enlarged side view of a portion of the motorcycle of FIG. 1 without a saddlebag.

FIG. 3 is a perspective view of two saddlebag mounting systems from the motorcycle of FIG. 1.

FIG. 4A is an exploded view of one of the saddlebag mounting systems shown in FIG. 3.

FIG. 4B is an enlarged exploded view of a portion of the saddlebag mounting system shown in FIG. 4A.

FIG. 5 is a rear view of the saddlebag mounting system shown in FIG. 4A including a saddlebag frame in an engaged position.

FIG. 6 is the rear perspective view of FIG. 5 with the saddlebag frame in a disengaged position.

FIG. 7 is an end perspective view of another construction of a locking bracket for use with the saddlebag mounting systems shown in FIG. 3.

FIG. 8 is a front perspective view of the locking bracket of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

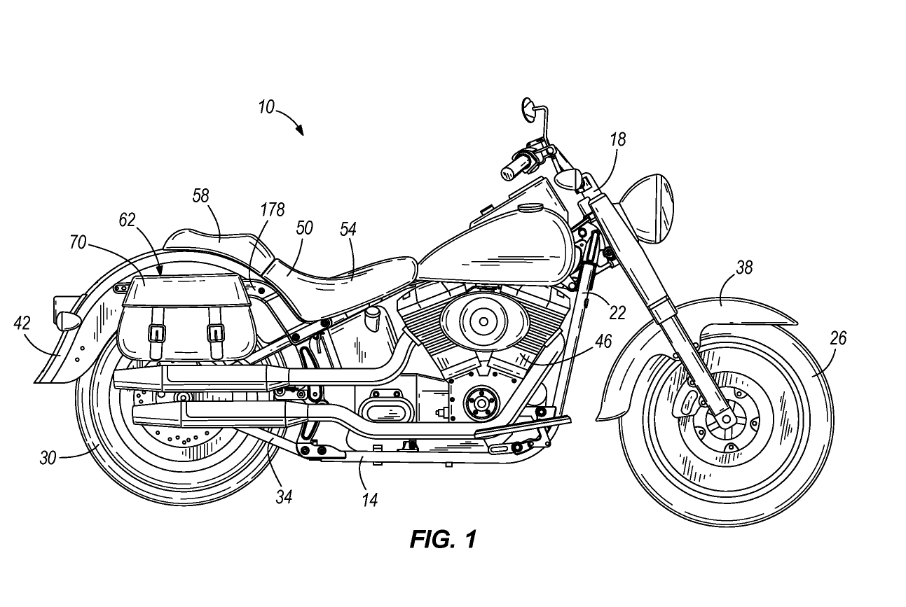

FIG. 1 illustrates a motorcycle 10 including a frame 14, a steering or handlebar assembly 18 pivotally mounted to a forward portion 22 of the frame 14, a front wheel 26 rotatably mounted to an end of the steering assembly 18, and a rear wheel 30 rotatably mounted to a rearward portion 34 of the frame 14. The illustrated frame 14 includes a front fender 38 extending over a portion of the front wheel 26 and a rear fender 42 extending over a portion of the rear wheel 30. An engine/transmission assembly 46 is mounted to the frame 14 and is coupled to the rear wheel 30 to drive the rear wheel 30. A seat 50 is coupled to the frame 14 to support a driver and a passenger. In the illustrated construction, the seat 50 includes a front seat portion 54 that supports the driver and a rear seat portion 58 that supports the passenger. The driver controls the engine/transmission assembly 46 to drive the rear wheel 30 and, thereby, propel the motorcycle 10. The driver pivots the steering assembly 18 to turn the front wheel 26 and steer the motorcycle 10 while the motorcycle 10 is moving.

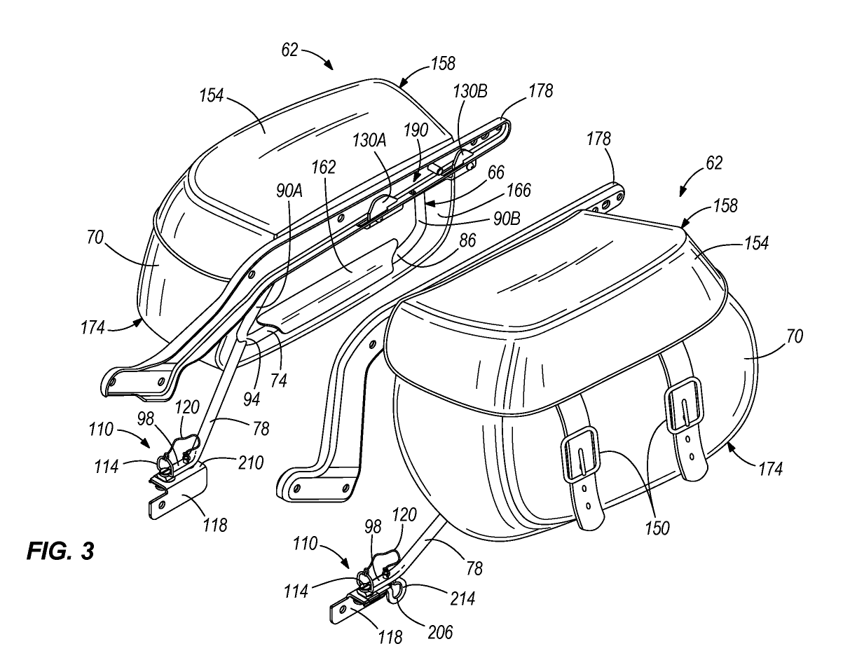

In the illustrated construction, a saddlebag mounting system 62 is supported on each side of the motorcycle 10. Although only one of the saddlebag mounting systems 62 is described in detail below, it should be readily apparent to one skilled in the art that the other saddlebag mounting system is substantially similar to, but a mirror image of, the described saddlebag mounting system 62. Where applicable in FIG. 3, like parts of each saddlebag mounting system 62 have been give the same reference numbers.

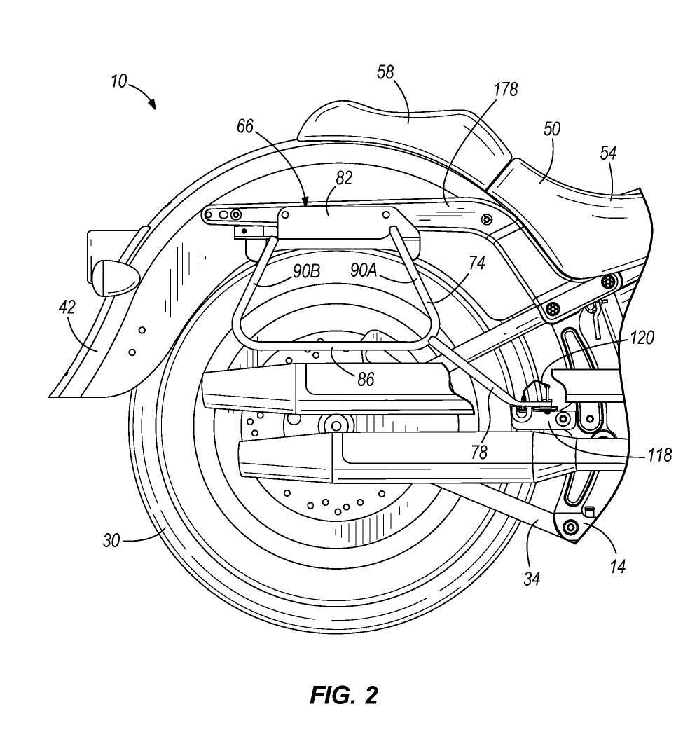

As shown in FIGS. 2-4A, the saddlebag mounting system 62 includes a saddlebag frame 66 that connects to the frame 14 of the motorcycle 10 and a saddlebag 70 coupled to and supported by the saddlebag frame 66. The illustrated saddlebag frame 66 includes a generally U-shaped support portion 74, an arm 78 extending outwardly from the support portion 74, and a bracket 82 coupled to the support portion 74. The saddlebag frame 66 may be painted, plated (e.g., chrome plated), or otherwise stylized to match or compliment the overall style of the motorcycle 10. In the illustrated construction, the support portion 74 is constructed from a single rod that is bent or otherwise deformed to define a generally horizontal mid portion 86 and two legs 90A, 90B. The legs 90A, 90B extend upwardly from the mid portion 86 and couple to the bracket 82. The illustrated legs 90A, 90B are angled toward one another such that the legs 90A, 90B are not perfectly perpendicular relative to the mid portion 86.

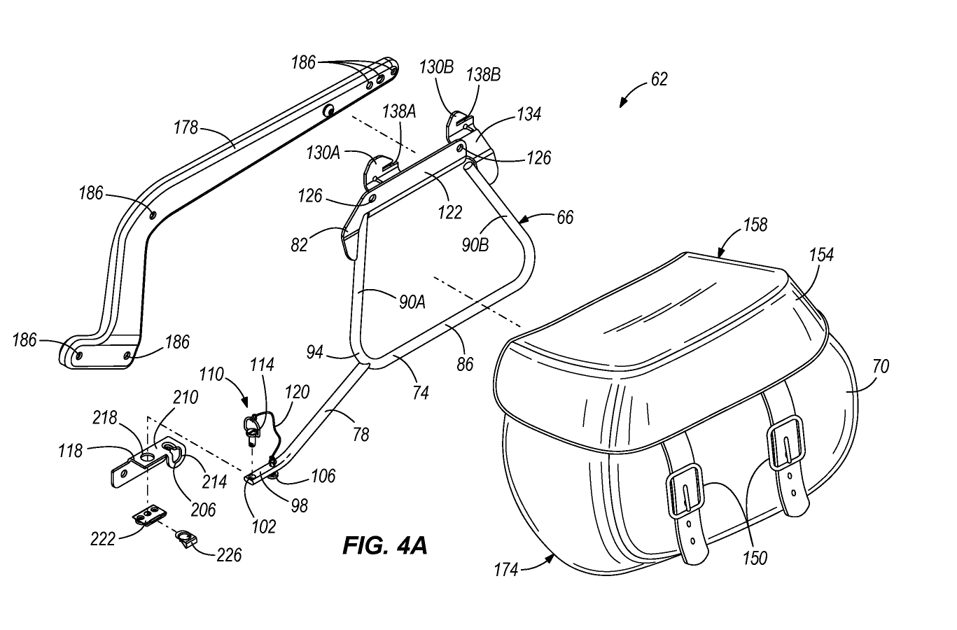

Referring to FIGS. 2 and 4A, the arm 78 extends from the support portion 74 toward the forward portion 22 of the motorcycle frame 14. In other constructions, the arm 78 may extend toward the rearward portion 34 of the motorcycle frame 14. The arm 78 is constructed from a rod having a similar shape and diameter as the support portion 74 and is welded to a corner 94 of the support portion 74 between the mid portion 86 and one of the legs 90A. In the other constructions, the arm 78 may be connected to the support portion 74 using other coupling means, or may be formed, cast, or machined as a single piece with the support portion 74.

The illustrated arm 78 includes a flattened end portion 98 defining an aperture 102 and supporting a downwardly extending lug 106 (FIGS. 4A and 4B). The aperture 102 receives a locking device 110 that extends through the flattened portion 98 of the arm 78 and engages a portion of the motorcycle frame 14 to secure and lock the flattened end portion 98 relative to the motorcycle frame 14. In the illustrated construction, the locking device 110 includes a quarter-turn fastener 114 that selectively engages a locking bracket 118 mounted to the motorcycle frame 14. The quarter-turn fastener 114 couples the arm 78 to the locking bracket 118 to resist movement between the flattened end portion 98 and the motorcycle frame 14. A flexible tether 120 is coupled to the fastener 114 and the lug 106 to keep the fastener 114 with the saddlebag frame 66 when the frame 66 is disconnected from the motorcycle frame 14. In other constructions, the locking device 110 may include other types of fasteners or brackets to help secure the flattened end portion 98 relative to the motorcycle frame 14.

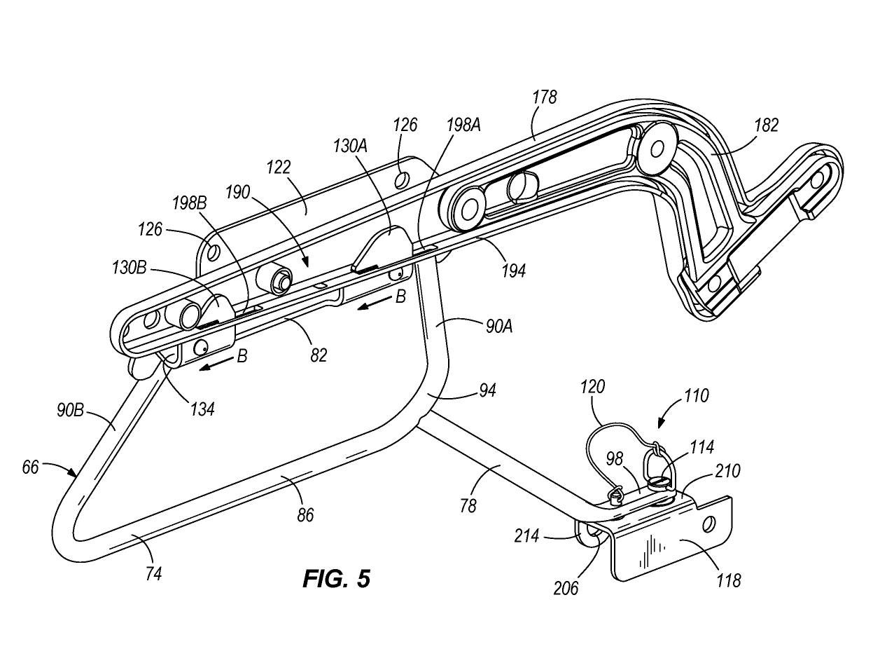

As shown in FIG. 4A, the bracket 82 is coupled (e.g., welded) to an end of one of the legs 90A of the support portion 74 and is slightly spaced apart from the other leg 90B. In some constructions, the bracket 82 may additionally or alternatively be coupled to the other leg 90B. The bracket 82 includes a vertical plate 122 defining a pair of apertures 126. The apertures 126 receive fasteners (e.g., bolts, rivets, or the like) to connect the saddlebag 70 to the saddlebag frame 66. The bracket 82 also includes two projections 130A, 130B extending upwardly from a horizontal plate 134 substantially parallel to and behind the vertical plate 122 (i.e., on a side of the vertical plate 122 opposite the saddlebag 70). In the illustrated construction, each projection 130A, 130B includes an undercut 138A, 138B, or slot, such that the projections 130A, 130B are substantially hook-shaped. The illustrated undercuts 138A, 138B receive portions of the motorcycle frame 14 to couple the saddlebag frame 66 to the motorcycle frame 14. As shown in FIG. 6, each undercut 138A, 138B includes an open end 142A, 142B and a closed end 146A, 146B such that the portions of the motorcycle frame 14 may slide into the undercuts 138A, 138B. In some constructions, each undercut 138A, 138B may be tapered from the open end 142A, 142B to the closed end 146A, 146B. In other constructions, the bracket 82 may include fewer or more projections 130A, 130B, and thereby undercuts 138A, 138B, than the amount illustrated.

In the illustrated construction, the saddlebag 70 is configured to store personal belongings of a driver and/or a passenger. In some constructions, the saddlebag 70 may be composed of leather, cloth, flexible plastic, or the like and may be colored to match or compliment the overall style of the motorcycle 10. Additionally, the saddlebag 70 may include buckles, snaps, buttons, draw strings, or the like such that a user may securely close the saddlebag. In the illustrated construction, the saddlebag 70 is a leather saddlebag including two buckles 150 to hold a top flap 154 of the saddlebag 70 in place.

As shown in FIG. 4A, the saddlebag 70 is coupled to the saddlebag frame 66 by fasteners extending through the apertures 126 in the bracket 82. The fasteners engage a top portion 158 of the saddlebag 70 to securely fasten the saddlebag 70 to the bracket 82 such that the saddlebag 70 may not be quickly and easily separated from the saddlebag frame 66. In some constructions, the saddlebag 70 may be connected to the bracket 82 using other coupling means (e.g., a quick release mechanism) such that a user may quickly remove the saddlebag 70 from the motorcycle 10 without having to also or first disconnect the saddlebag frame 66 from the motorcycle frame 14.

Referring to FIG. 3, the illustrated saddlebag 70 includes a flange 162 supported on a back surface 166 of the saddlebag 70. The flange 162 is composed of a hard plastic or rubberized material and partially surrounds the mid portion 86 of the support portion 74. When the saddlebag 70 is coupled to saddlebag frame 14, the flange 162 engages the mid portion 86 to inhibit separation of a bottom portion 174 of the saddlebag 70 from the saddlebag frame 14. In other constructions, the back surface 166 of the saddlebag 70 may include extra fabric material forming a pouch or flap. The pouch or flap may receive and wrap around the saddlebag frame 66 to cover the saddlebag frame 66 and inhibit separation of the saddlebag 70 from the saddlebag frame 66.

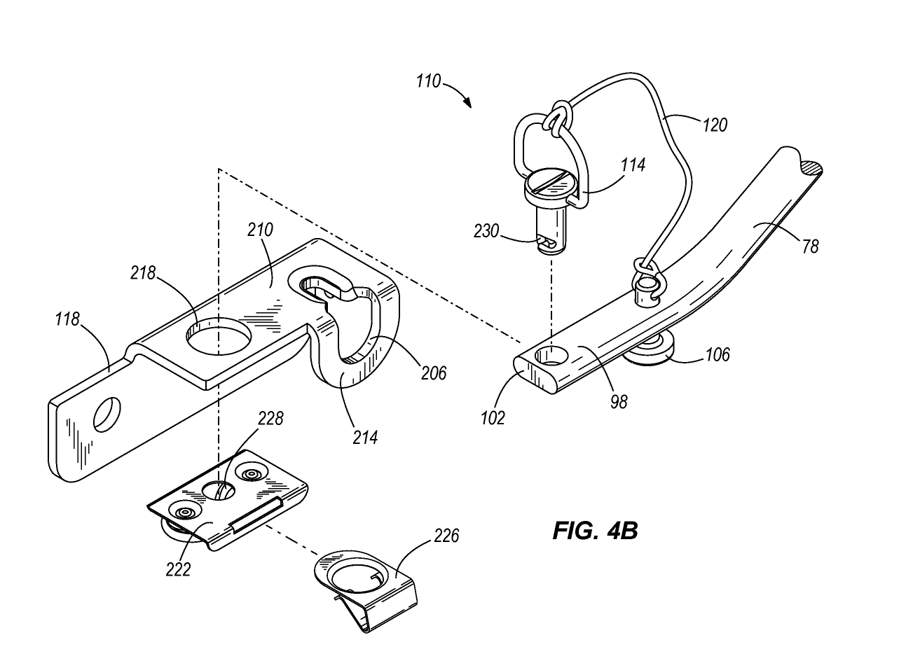

As shown in FIGS. 2-6, the saddlebag mounting system 62 couples to a portion of the frame 14 of the motorcycle 10. In the illustrated construction, the frame 14 includes a fender strut cover 178 that receives a portion of the saddlebag mounting system 62 to couple the saddlebag mounting system 62 to the motorcycle 10. In other constructions, the saddlebag mounting system 62 may couple to other suitable components of the motorcycle frame 14 such as, for example, directly to a fender strut, to the rear fender 42, or the like. The illustrated fender strut cover 178 substantially covers a fender strut 182 (FIGS. 5 and 6) of the motorcycle 10 and extends over a portion of the rear fender 42. In the illustrated construction, the fender strut cover 178 includes a series of apertures 186 (FIG. 4A) to facilitate mounting the fender strut cover 178 to the fender strut 182 and, if necessary, to the rear fender 42. Similar to the saddlebag frame 66, the fender strut cover 178 may be painted, plated (e.g., chrome plated), or otherwise stylized to match or compliment the overall style of the motorcycle 10.

As shown in FIGS. 5 and 6, the fender strut cover 178 is substantially hollow such that, when mounted to the fender strut 182, the fender strut cover 178 defines a cavity 190 between the rear fender 42 and the fender strut cover 178. A bottom wall 194 of the fender strut cover 178 defines two apertures 198A, 198B in communication with the cavity 190. The apertures 198A, 198B generally correspond to the position, size, and spacing of the projections 130A, 130B on the bracket 82. In the illustrated construction, the apertures 198A, 198B are slots configured to receive the projections 130A, 130B. In other constructions, the apertures 198A, 198B may be cutouts extending to an edge of the bottom wall 194. When the projections 130A, 130B are inserted through the slots 198A, 198B, the projections 130A, 130B extend into the cavity 190 such that they are not visible to an observer looking at the motorcycle 10. That is, as shown in FIG. 2, the projections 130A, 130B are substantially hidden from view when the saddlebag frame 66 is coupled to the fender strut cover 178, even if the saddlebag 70 is not present.

Referring back to FIGS. 5 and 6, the illustrated bottom wall 194 has a thickness approximately equal to, but slightly less than a height of the undercuts 138A, 138B such that the projections 130A, 130B frictionally engage the bottom wall 94 to couple the saddlebag frame 66 to the motorcycle frame 14. The bottom wall 194 includes an elastomeric pad 202A, 202B (FIG. 6) adjacent to each slot 198A, 198B such that the projections 130A, 130B engage the pads 202A, 202B to resist sliding along the fender strut cover 178 and to inhibit rattling of the projections against the strut cover 178. The pads 202A, 202B also reduce scratching or otherwise wearing of the saddlebag frame 66 and the fender strut cover 178 when the projections 130A, 130B move relative to the fender strut cover 178.

The locking bracket 118 is mounted (e.g., bolted) to the motorcycle frame 14 adjacent to the rear wheel 30. In some constructions, the locking bracket 118 may be mounted to an existing bolt on a passenger foot peg bracket. The locking bracket 118 receives the lug 106 of the arm 78 and the locking device 110 to lock the saddlebag frame 66 in place on the motorcycle 10. The illustrated locking bracket 118 defines an opening 206 extending through a top wall 210 and a sidewall 214 of the bracket 118 to receive the lug 106. The top wall 210 of the locking bracket 118 also defines an aperture 218 to receive the locking device 110.

As shown in FIG. 4B, the locking bracket 118 includes a receiver 222 positioned adjacent to and beneath the aperture 218 and a clip 226 to connect the receiver 222 to the locking bracket 118. When the lug 106 is positioned in the opening 206 in the locking bracket 118, the aperture 102 in the arm 78 aligns with the aperture 218 in the locking bracket 118 such that the fastener 114 may be inserted through both apertures 102, 218 and into the receiver 222. The receiver 222 includes a spring 228 that fits within a slot 230 in the quarter-turn fastener 114 when the fastener 114 is inserted into the receiver 222. As a user rotates the fastener 114 (e.g., about 90 degrees clockwise), the spring 228 slides into a cammed portion of the slot 230, pulling the fastener 114 and the receiver 222 together on opposite sides of top wall 210 to secure the fastener 114 in place. Rotating the fastener 114 in an opposite direction (e.g., about 90 degrees counterclockwise) releases the spring 228 from the cammed portion of the slot 230 such that the user can pull the fastener 114 out of the receiver 222 and the apertures 102, 218.

In some constructions (not shown), a glove or other cover may be positioned over the locking bracket 118, the locking device 110, and/or the flattened end portion 98 of the arm 78 to substantially cover the locking bracket 118. In such constructions, the glove may cover the locking bracket 118 when the saddlebag frame 66 is or is not connected to the motorcycle frame 14. The glove may help hold the locking device 110 in place and may help protect the locking bracket 118 from being damage. In addition, the glove may be colored or stylized to match or compliment the overall style of the motorcycle 10.

To connect the saddlebag mounting system 62 to the motorcycle 10, a user aligns the projections 130A, 130B of the bracket 82 underneath the slots 198A, 198B in the bottom wall 194 of the fender strut cover 178. As shown in FIG. 6, the user inserts the projections 130A, 130B through the slots 198A, 198B in a first direction, designated by arrows A, such that the undercuts 138A, 138B defined by the projections 130A, 130B are substantially aligned with the bottom wall 194 of the fender strut cover 178. The user then slides the saddlebag frame 66 and the saddlebag 70 relative to the fender strut cover 178 in a second direction, designated arrows B (FIG. 5), that is substantially normal to the first direction. As shown in FIG. 5, the saddlebag frame 66 is slid relative to the fender strut cover 178 until the bottom wall 194 contacts the closed ends 146A, 146B of the undercuts 138A, 138B. The projections 130A, 130B thereby frictionally engage the elastomeric pads 202A, 202B adjacent to the slots 198A, 198B to releasably hold the saddlebag mounting system 62 in an engaged position.

After the projections 130A, 130B are inserted into the cavity 190 and the undercuts 138A, 138B receive portions of the bottom wall 194, the flattened end portion 98 is aligned with the locking bracket 118. If necessary, the arm 78 may be slightly deflected to help position the lug 106 within the opening 206 in the locking bracket 118. Once the lug 106 is properly positioned, the aperture 102 in the flattened end portion 98 and the aperture 218 in the locking bracket 118 are aligned such that the user may insert the quarter-turn fastener 114 through both apertures 102, 218. The user then rotates the fastener 114 to lock the arm 78, and thereby the saddlebag frame 66, relative to the motorcycle frame 14.

To disconnect the saddlebag mounting system 62 from the motorcycle 10, the operation described above is performed in reverse. The user rotates the quarter-turn fastener 114 in the opposite direction and removes the fastener 114 from the apertures 102, 218. The user then slightly deflects the arm 78, if necessary, to remove the lug 106 from the opening 206 in the locking bracket 118. Once the lug 206 is clear of the locking bracket 118, the user slides the saddlebag frame 66 and the saddlebag 70 relative to the motorcycle frame 14 in a direction substantially opposite the second direction (i.e., opposite the arrows B in FIG. 5) such the portions of the bottom wall 194 are no longer received in the undercuts 138A, 138B and engaged by the projections 130A, 130B. The saddlebag frame 66 is thereby slid from the engaged position (FIG. 5) to a disengaged, or removable, position (FIG. 6). The user then pulls the projections 130A, 130B out of the cavity 190 in the fender strut cover 178 in a direction substantially opposite the first direction (i.e., opposite the arrows A in FIG. 6). The saddlebag mounting system 62 is thereby disconnected from the motorcycle frame 14.

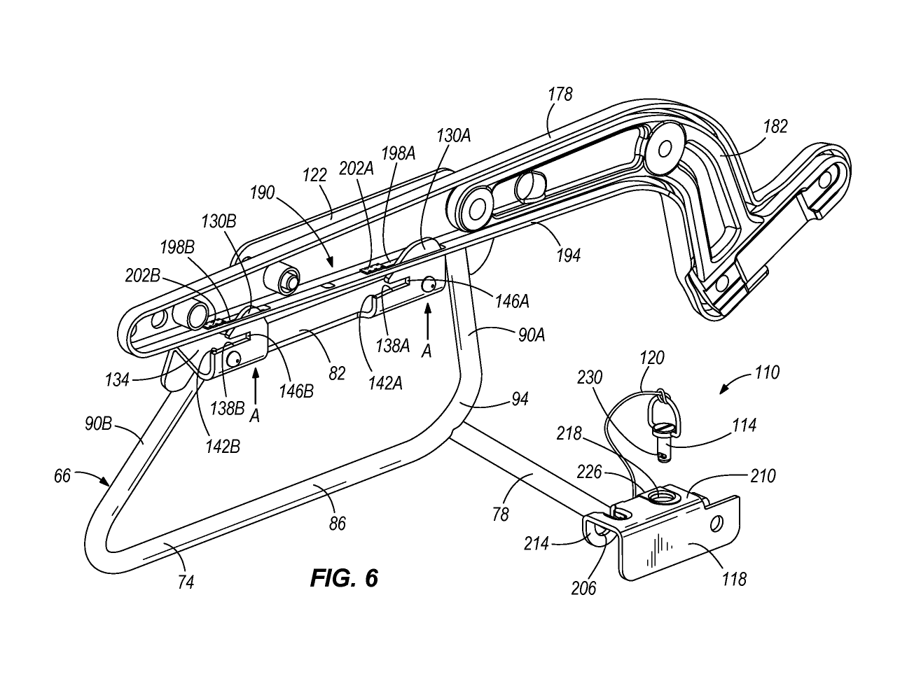

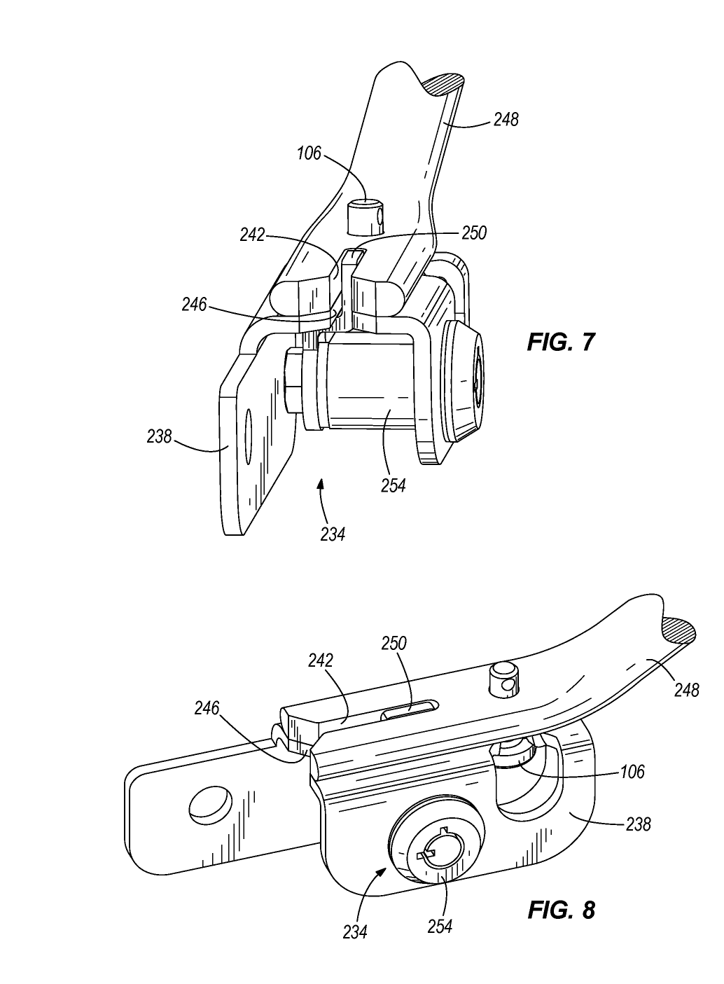

FIGS. 7 and 8 illustrate another construction of a locking device 234 and a locking bracket 238 for use with a saddlebag mounting system. In the illustrated construction, the apertures 102, 218 in the arm 78 and the locking bracket 118 of FIGS. 2-6 are replaced with corresponding slots 242, 246 in an arm 248 and the locking bracket 238. In addition, the quarter-turn fastener 114 of the locking device 110 shown in FIG. 2-6 is replaced with a locking arm 250 and a lock cylinder 254. The locking arm 250 is coupled to the lock cylinder 254 such that rotation of the lock cylinder 254 rotates the locking arm 250 into and out of the slots 242, 246. The illustrated lock cylinder 254 requires a key to rotate the locking arm 250, although in other constructions, the lock cylinder 254 may include an external actuator, button, or lever to rotate the locking arm 250 without a key. Similar to the quarter-turn fastener 114, when the locking arm 250 is positioned within the slots 242, 246, the locking arm 250 resists movement of the arm 248 relative to the locking bracket 238, thereby securing the saddlebag frame to the motorcycle frame.

Various features and advantages of the invention are set forth in the following claims.

What is claimed is:

1. A saddlebag mounting system for use with a motorcycle, the motorcycle defining an aperture, the saddlebag mounting system comprising:
a saddlebag frame including a projection configured to extend at least partially through the aperture and having an undercut, the undercut configured to receive a portion of the motorcycle adjacent to the aperture to couple the saddlebag frame to the motorcycle; and
a saddlebag coupled to the saddlebag frame.

2. The saddlebag mounting system of claim 1, wherein the saddlebag frame is movable relative to the motorcycle frame in a first direction and in a second direction substantially normal to the first direction.

3. The saddlebag mounting system of claim 1, wherein the saddlebag frame is slidable between a first position in which the saddlebag frame is removable from the motorcycle frame, and a second position in which the undercut engages the portion of the motorcycle frame adjacent to the aperture.

4. The saddlebag mounting system of claim 1, wherein the motorcycle defines a second aperture and the saddlebag frame includes a second projection having a second undercut, wherein the second projection is configured to extend at least partially through the second aperture, and wherein the second undercut is configured to receive a portion of the motorcycle adjacent to the second aperture to couple the saddlebag frame to the motorcycle.

5. The saddlebag mounting system of claim 1, further comprising a locking device configured to resist movement between the motorcycle and the saddlebag frame.

6. The saddlebag mounting system of claim 5, wherein the motorcycle includes a locking bracket and the saddlebag frame includes an arm, and wherein the locking device selectively couples the arm and the locking bracket.

7. The saddlebag mounting system of claim 1, wherein the saddlebag includes a flange engaging a portion of the saddlebag frame to inhibit separation of the saddlebag from the saddlebag frame.

8. The saddlebag mounting system of claim 1, wherein the aperture is a slot formed in a fender strut cover of the motorcycle.

9. A motorcycle comprising:
a motorcycle frame defining an aperture; and
a saddlebag mounting system including
a saddlebag frame including a projection extending at least partially through the aperture and having an undercut, the undercut receives a portion of the motorcycle frame adjacent to the aperture to couple the saddlebag frame and the motorcycle frame, and
a saddlebag coupled to the saddlebag frame.

10. The motorcycle of claim 9, wherein the saddlebag frame is movable relative to the motorcycle frame in a first direction and in a second direction substantially normal to the first direction.

11. The motorcycle of claim 9, wherein the saddlebag frame is slidable between a first position in which the saddlebag frame is removable from the motorcycle frame, and a second position in which the undercut engages the portion of the motorcycle frame adjacent to the aperture.

12. The motorcycle of claim 9, wherein the motorcycle frame defines a second aperture and the saddlebag frame includes a second projection having a second undercut, wherein the second projection extends at least partially through the second aperture, and wherein the second undercut is receives a portion of the motorcycle frame adjacent to the second aperture to couple the saddlebag frame and the motorcycle frame.

13. The motorcycle of claim 9, further comprising a locking bracket coupled to the motorcycle frame, wherein the saddlebag mounting system includes a locking device and the saddlebag frame includes an arm, and wherein the locking device selectively couples the arm and the locking bracket to resist movement between the motorcycle frame and the saddlebag frame.

14. The motorcycle of claim 9, wherein the motorcycle frame includes a fender strut cover, and wherein the aperture is a slot formed in the fender strut cover.

15. The motorcycle of claim 9, wherein the portion of the motorcycle frame adjacent to the aperture includes a pad, and wherein the projection engages the pad when the undercut receives the portion of the motorcycle frame.

16. A method of attaching a saddlebag frame to a motorcycle, the motorcycle including a motorcycle frame defining an aperture, the method comprising:
providing a projection including an undercut on the saddlebag frame;
inserting the projection at least partially through the aperture;
sliding the saddlebag frame relative to the motorcycle frame;
positioning a portion of the motorcycle frame within the undercut, the portion of the motorcycle frame being adjacent to the aperture; and
coupling the saddlebag frame to the motorcycle frame.

17. The method of claim 16, further comprising coupling a locking device between the saddlebag frame and the motorcycle frame, and resisting movement between the saddlebag frame and the motorcycle frame with the locking device.

18. The method of claim 16, wherein inserting the projection includes inserting the projection at least partially through the aperture in a first direction, and sliding the saddlebag frame includes sliding the saddlebag frame relative to the motorcycle frame in a second direction substantially normal to the first direction.

19. The method of claim 16, wherein the motorcycle frame defines a second aperture and the saddlebag frame includes a second projection including a second undercut, and further comprising
inserting the second projection at least partially through the second aperture, and
positioning a second portion of the motorcycle frame within the second aperture, the second portion of the motorcycle frame being adjacent to the second aperture.

20. The method of claim 16, wherein the motorcycle frame defines a cavity in communication with the aperture, and wherein inserting the projection includes inserting the projection at least partially through the aperture and into the cavity such that the projection and the aperture are not visible when viewing the motorcycle.
